(19) United States
(12) Patent Application Publication
(10) Pub. No.: US 2013/0100285 A1
(43) Pub. Date: Apr. 25, 2013

(54) Method for Comparing Effects of Equipment on a User's Head Mobility

(71) Applicant: Joshua David Hogge, Great Mills, MD (US)

(72) Inventor: Joshua David Hogge, Great Mills, MD (US)

(73) Assignee: Department of the Navy, Patuxent River, MD (US)

(21) Appl. No.: 13/596,153

(22) Filed: Aug. 28, 2012

Related U.S. Application Data
(60) Provisional application No. 61/550,562, filed on Oct. 24, 2011.

(51) Int. Cl. H04N 7/18

(52) U.S. Cl. 348/143; 348/E07.085

(57) ABSTRACT

A method for comparing effects of equipment on a user's head mobility, which includes attaching a camera and a laser pointer on a user's head, the camera capturing the laser point and the trace of the laser pointer against a spatial reference, adjusting the laser pointer such that the laser pointer points outwardly in the direction of the line of sight of the user, configuring a work area such that the work area is constant, placing the user wearing the equipment the camera, and the laser pointer in the work area, scanning the full range of motion of the user wearing the equipment while recording the trace of the laser pointer via the camera, repeating the above listed acts with a different equipment configuration, and comparing and reviewing the recordings of the trace of the laser pointer for the equipment configurations to compare each configuration's effects on head mobility.

### CROSS REFERENCES

The present invention claims the benefit of Provisional Application No. 61/550,562 filed Oct. 24, 2011. The application is incorporated herein by reference, and is not admitted to be prior art with respect to the present invention.

### STATEMENT OF GOVERNMENT INTEREST

The invention described herein may be manufactured and used by or for the Government of the United States of America for government purposes without payment of any royalties thereon or therefor.

### BACKGROUND

The United States Navy utilizes various equipment on its personnel. The equipment may be protective equipment or equipment that may help the user to perform a mission, such as, but without limitation, night vision goggles, aircrew life support equipment, dry suits, aircrew respirators, chemical/biological protective masks, or protective head gear. For instance, many aircraft personnel wear a helmet. Often the helmet may have mounted gear on the helmet, which may affect head mobility. Additionally, personnel may wear a safety harness, or any other type of equipment that limits mobility, which can also limit head mobility. Prior to widespread use of any equipment, the equipment must be tested to determine if the equipment has any affect on head mobility, which can prevent a user from performing mission critical functions.

The effects of personal equipment on head mobility have formerly been measured with elaborate and costly head tracking systems, such as systems utilizing Polhemus wireless motion tracking technology. The major drawbacks of this technology are that it is costly, requires an elaborate laboratory setup, and cannot be utilized in an environment which contains metallic objects. Additionally, wireless systems are not conducive for use within an operational simulator or aircraft cockpit. Therefore, this technology cannot be utilized in an aircraft cockpit or a manned flight simulator. It can only be determined in an aircraft cockpit or a representative work area whether there is adequate head mobility to perform aircraft mission essential functions or other functions required to perform duties safely.

### SUMMARY

The present invention is directed to a method for comparing effects of equipment on a user's head mobility that meets the needs enumerated above and below.

The present invention is directed to a method for comparing effects of equipment on a user's head mobility, which includes the acts of attaching a camera and a laser pointer on the head of a user, the laser pointer having a laser point and a trace, the camera, capturing the laser point of the laser pointer and the trace against a spatial reference, adjusting the laser pointer such that the laser pointer points outwardly in the direction of the line of sight of the user and from between the user's eyes on the sagittal plane, configuring a work area such that the work area is constant and substantially similar to an area that the equipment would be used in, placing the user wearing the equipment, the camera, and the laser pointer in the work area, scanning the full range of motion of the user wearing the equipment while recording the trace of the laser pointer via the camera, repealing the above listed acts with a different equipment configuration, and comparing and reviewing the recordings of the trace of the laser pointer for the equipment configurations to compare each configuration's effects on head mobility.

It is a feature of the present invention to provide a method for comparing effects of equipment on a user's head mobility that can be utilised in an aircraft cockpit or manned-flight simulator.

It is a feature of the present invention to provide a method for comparing effects of equipment on a user's head mobility that is inexpensive and quicker compared to previously used methods.

### DESCRIPTION

The preferred embodiments of the present invention are illustrated by way of example below. The method for comparing effects of equipment on a user's head mobility includes the acts of attaching a camera and a laser pointer on the head of a user, adjusting the laser such that the laser pointer points outwardly in the direction of the line of sight of the user and from between the user's eyes on the sagittal plane (and parallel to the axial plane when the user is upright), configuring a work area such that the work area is constant and substantially similar to an area that the equipment would be used in, placing the user wearing the equipment, the camera, and the laser pointer in the work area, scanning the full range of motion of the user wearing the equipment while recording the trace of the laser via the camera, repeating the above listed acts with a different equipment configuration, and comparing and reviewing the recordings of the trace of the laser pointer for the equipment configurations to compare each configuration's effects on head mobility.

In the description of the present invention, the invention will be discussed in a military environment; however, this invention can be utilized for any type of application that requires use of a method for comparing effects of equipment on a user's head mobility. This may include, but without limitation, a sports environment, any industrial environment, any vehicle environment such as bicycles, motorcycles, stock cars, etc.

This method may be used to test a user's head mobility of any man mounted gear that is worn. The gear may be, but without limitation, worn on a user's torso, neck, or head. The method may also be utilized to evaluate workplace or cockpit setups such as, but without limitation, seats, seat harnesses, and workplace layouts.

A sagittal plane may be defined, but without limitation, as a longitudinal plane that divides the body of a bilaterally symmetrical animal into right and left sections. An axial plane may be defined, but without limitation, as a hypothetical plane perpendicular to the long axis of the human body. A line of sight may be defined, but without, limitation, as the straight line along which an observer looks. A full range of motion may be defined, but without limitation, as the range a person can move his or her joints or a group of joints.

A laser pointer may be defined, but without limitation, as a portable laser that emits monochromatic light over a long and narrow distance, used especially as a pointing device. A trace may be defined, but without limitation, as a footprint or indication that a light (the light of the laser pointer) was present.

In the preferred embodiment, the camera is a wearable HD video and still photo camera. It may also include a microphone to record test subject/user feedback. The preferred laser pointer is a low power business presentation quality pointer.

Preferably, when placing the user in the work area, a plumb line should be used to center the user in his/her seat and center the laser point on the midline of the work area. A plumb line may be defined, but without limitation, as line regarded as directed exactly toward the Earth's center of gravity.

In one of the embodiments of the invention, the video data is plotted on photographs of the work area. This allows an evaluator to compare the plotted data for the various configurations and thus compare the effects of different equipment configurations on a user's head mobility.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for comparing effects of equipment on a user's head mobility, the user having a head, eyes, a sagittal plane, a line of sight and a full range of motion, the method comprising the acts of:
attaching a camera and a laser pointer on the head of a user, the laser pointer having a laser point and a trace, the camera capturing the laser point of the laser pointer and the trace against a spatial reference;
adjusting the laser pointer such that the laser pointer points outwardly in the direction of the line of sight of the user and from between the user's eyes on the sagittal plane;
configuring a work area such that the work area is constant and substantially similar to an area that the equipment would be used in;
placing the user wearing the equipment, the camera, and the laser pointer in the work area;
scanning the full range of motion of the user wearing the equipment while recording the trace of the laser pointer via the camera;
repeating the above listed acts with a different equipment configuration; and,
comparing and reviewing the recordings of the trace of the laser pointer for the equipment configurations to compare each configuration's effects on head mobility.

2. The method of claim 1, further comprising centering the user and the laser pointer using a plumb line.

3. The method of claim 2, wherein the camera is a wearable HD video and still photo camera.
